(19) United States
(12) Patent Application Publication
(10) Pub. No.: US 2026/0288564 A1
(43) Pub. Date: Sep. 24, 2026

(54) SMART FFDC COLLECTION

(71) Applicant: Lenovo Global Technology (United States) Inc., Morrisville, NC (US)

(72) Inventors: Abhay Satpute, Pune (IN); Kamal Kumar Maharana, Bangalore (IN)

(21) Appl. No.: 19/086,272

(22) Filed: Mar. 21, 2025

(51) Int. Cl. G06F 11/07

(52) U.S. Cl. CPC G06F 11/0787; G06F 11/0721

(57) ABSTRACT

A computer program product causes a processor to receive an alert from a management controller of an individual endpoint, wherein the alert identifies an alert type and a component within the endpoint that triggering the alert, and wherein the component is a hardware device, software module or firmware file. The alert is forwarded to a failure analysis data collector as a prompt to generate a collection list of log files for a failure event data log file, wherein the failure analysis data collector service includes an artificial intelligence model trained to generate the collection list based on the alert. The collection list is received, a plurality of log files are collected, a failure event data log file is formed including the log files identified in the collection list and excluding other log files, and the failure event data log file is sent to a service support node.

### BACKGROUND

The present disclosure relates to systems and methods for transferring data that is useful for analyzing the cause of a system failure in a computing system.

### Background of the Related Art

When a computer system experiences an alert, a system administrator or engineer may want to determine the cause or circumstances of the alert. A first step toward determining the cause or circumstances of the alert is to collect recent operating data for various endpoints and system management software log files of the computer system. These endpoints may include any number of servers, edge servers, switches, fans, power supplies, and storage devices. Furthermore, an endpoint may be a Flex System Enterprise Chassis or a ThinkSystem available from Lenovo. Operating data from some endpoints may be collected from a management controller residing on the endpoint, such as a baseboard management controller residing on a server, as well as the operating system for that endpoint. The system management software log files may be collected from a system management software, such as Lenovo XClarity Administrator (LXCA) and/or Lenovo XClarity Orchestrator (LXCO). The log files collected from system management software may include log files from multiple modules of the system management software, such as a database module, gateway module, events module, caching module, timer module, job scheduling module and/or other modules.

A failure analysis data capture module, such as a first failure data capture (FFDC) module, running on one of the system management nodes may automatically initiate collection of the relevant operating data, which may be referred to as a failure event data log, such as a first failure data capture (FFDC) file, for the relevant computer system. Once all of the relevant operating data has been collected by the failure analysis data capture module of the system management node, the failure event data log may be uploaded to a vendor upload facility to be analyzed with the purpose of determining the cause or circumstances of the alert. However, the size of the individual log files grows as the number of endpoints being managed by the system management software increases. Accordingly, the size of the failure analysis log data collected from all of the endpoints and system management software modules also increases.

### BRIEF SUMMARY

Some embodiments provide a computer program product comprising a non-transitory computer readable medium and program instructions embodied therein, the program instructions being configured to be executable by a processor to cause the processor to perform various operations. The operations comprise receiving an alert from a management controller of an individual endpoint, wherein the alert identifies an alert type and a component within the endpoint that experienced a condition triggering the alert, wherein the component is a hardware device, software module or firmware file. The operations further comprise forwarding, in response to receiving the alert, the alert to a failure analysis data collector as a prompt to generate a collection list of log files and/or folders to be included in a failure event data log file, wherein the failure analysis data collector service includes an artificial intelligence (AI) model trained to generate the collection list based on information identified by the alert. Still further, the operations comprise receiving the collection list from the failure analysis data collector, collecting a plurality of log files and/or folders from the management controller, a local operating system on the individual endpoint, and/or system management software that manages the endpoint, forming a failure event data log file including the log files and/or folders identified in the collection list and excluding other log files and/or folders received that are not identified in the collection list, and sending the failure event data log file to a service support node.

Some embodiments provide a method comprising various operations and/or a computer program product comprising a non-transitory computer readable medium and program instructions embodied therein, the program instructions being configured to be executable by a processor to cause the processor to perform various operations. The operations of the method and/or the computer program product comprise training an artificial intelligence (AI) model using a training dataset including a plurality of failure event data log files, wherein each failure event data log is labeled with an alert that caused generation of the failure event data log files and a desired collection list. The training causes the artificial intelligence model to determine weights of a plurality of parameters of the artificial intelligence model. The operations further comprise receiving a plurality of alerts as prompts for input to the artificial intelligence model, and generating and outputting, for each of the plurality of alerts, a collection list identifying the log files and/or folders to be collected by the system management software and sent to a service support node as a failure event data log file for analyzing a cause of the alert. Still further, the operations comprise performing recursive training of the artificial intelligence model, wherein the recursive training includes, for each of the plurality of alerts, calculating a loss function that identifies a difference between the collection list output by the artificial intelligence model and an intended collection list for the alert, and adjusting the weights of the plurality of parameters of the artificial intelligence model.

### BRIEF DESCRIPTION OF THE SEVERAL VIEWS OF THE DRAWINGS

FIG. 1 is a diagram of a system that forms a failure event data log file having a reduced set of files and folders selected by an artificial intelligence model and provided to the service support.

FIG. 2 is a diagram of a computer that runs the failure analysis data collector.

FIG. 3 is a diagram of an artificial intelligence reinforcement learning algorithm for training an artificial intelligence model to form a collection list that identifies select files and folders for failure analysis data capture.

FIG. 4 is a diagram of a computer server according to some embodiments.

FIG. 5 is a diagram of a baseboard management controller (BMC) according to some embodiments.

FIG. 6 is a flowchart of an embodiment of operations that may be performed by a processor of a host node or other computer.

### DETAILED DESCRIPTION

Some embodiments provide a computer program product comprising a non-transitory computer readable medium and program instructions embodied therein, the program instructions being configured to be executable by a processor to cause the processor to perform various operations. The operations comprise receiving an alert from a management controller of an individual endpoint, wherein the alert identifies an alert type and a component within the endpoint that experienced a condition triggering the alert, wherein the component is a hardware device, software module or firmware file. The operations further comprise forwarding, in response to receiving the alert, the alert to a failure analysis data collector as a prompt to generate a collection list of log files and/or folders to be included in a failure event data log file, wherein the failure analysis data collector service includes an artificial intelligence (AI) model trained to generate the collection list based on information identified by the alert. Still further, the operations comprise receiving the collection list from the failure analysis data collector, collecting a plurality of log files and/or folders from the management controller, a local operating system on the individual endpoint, and/or system management software that manages the endpoint, forming a failure event data log file including the log files and/or folders identified in the collection list and excluding other log files and/or folders received that are not identified in the collection list, and sending the failure event data log file to a service support node.

The computer program product may be implemented in an instance of system management software. The system management software may be performed in a cloud computing environment or on a standalone computing node, which is referred to as a system management node. The system management software generally provides tools or modules to monitor and manage a plurality of endpoint devices. In some embodiments, the system management software includes a plurality of software modules, wherein some of the log files and/or folders may be collected from two or more of the plurality of modules.

Each individual endpoint is a component of equipment used in a computing system. For example, an individual endpoint may be a server, switch, fan, power supply, and/or storage device. Most preferably, a computing system will include a plurality of endpoints of various types. In some embodiments, a computing system will include a plurality of servers (endpoints), where each endpoint includes a management controller. For example, the management controller may be a baseboard management controller (BMC), such as the Lenovo XClarity Controller (XCC). Some of the endpoints, including a server, will also have a central processing unit that runs an operating system. In some embodiments, the management controller and/or the operating system may send alerts to the system management software and may also send log files and/or folders to the system management software.

In some embodiments, the alert may be categorized by the type of alert. Without limitation, the alert may have an alert type selected from a serviceable alert, warning alert or critical alert. Furthermore, the alert may identify the internal hardware device within the endpoint by the type of the internal hardware device and/or the specific unit of the internal hardware device. Without limitation, the internal hardware device type may be selected from a graphics card, solid state drive, hard disk drive, memory module, and network interface controller. Optionally, a specific unit of the internal hardware device may be identified by a device serial number or other unique identifier.

In some embodiments, one or more types of alerts may trigger an automatic notification. A “call home alert” is an automated notification sent by a device or system to a designated destination when a critical alert occurs, typically providing details about the problem and therefore allowing an investigation into the problem to begin. In some embodiments, a designated call home destination may be an instance of the system management software, such as system management administrative software managing a plurality of endpoints or system orchestration software managing the system management administrative software. The failure event data log file is preferably formed by the system management software that has been designated as the call home destination. In some embodiments, the system management software may include a plurality of instances of system management administrative software and one instance of system orchestration software managing the plurality of instances of the system management administrative software, wherein each instance of the system management administrative software system manages a plurality of endpoints. In the latter system, the failure event data log file is preferably formed by the system orchestration software. However, it should be recognized that the call home destination may be a configurable setting.

The failure analysis data collector includes the artificial intelligence model that has been trained to generate the collection list based on information identified by the alert. However, it is important to distinguish the collection list from the actual collection of log files and/or folders. The failure analysis data collector generates the collection list and provides the collection list to the system management software. Then, it is the system management software that forms the failure event data log file including the log files and/or folders identified in the collection list, but excluding other log files and/or folders that may have been received by the system management software yet are not identified in the collection list. Accordingly, the failure event data log file will typically include a subset of all the log files and folders that are collected or received by the system management software.

The system management software that includes the foregoing computer program product collects a plurality of log files and/or folders from various sources within the computing system. Without limitation, one or more log files and/or folders may be collected from the management controller, a local operating system on the individual endpoint, and/or system management software that manages the endpoint. Furthermore, the system management software may collect an additional plurality of log files and/or folders from additional endpoints being managed by the same system management software that manages the endpoint from which the alert is received. The system management software may collect the log files and/or folders by simply receiving the log files and/or folders sent by another entity in the system with or without sending a request for those log files and/or folders. In other words, some entities such as a baseboard management controller may automatically push one or more log files and/or folders to the system management software in response to the alert condition. Other entities, such as a module of the system management software itself, may send log files and/or folders in response to a request from another module of the system management software that is responsible for collecting log files and/or folder.

The system management software forms the failure event data log file including the log files and/or folders identified in the collection list. The failure event data log file should also include, or be accompanied by, information about the alert that led to the formation of the failure event data log file. In one option, the failure event data log file may be formed or saved in a tape archive file type with multiple files and directories together into a single container. Furthermore, the failure event data log file may contain nested zip files based on the source of the data, such as the endpoints and/or software modules from which the individual log files are collected. In a further option, the system management software may compress the failure event data log file before sending the failure event data log file to the service support node.

The service support node is accessible to a support team (personnel) that is involved in failure event data log file analysis to determine the cause(s) of the device condition that led to the alert. Accordingly, the service support node, such as the Lenovo Upload Facility (LUF), receives the failure event data log file and makes it available to the support team. For example, the Lenovo Upload Facility (LUF) is a service supported by a team of experts that may communicate with a support person managing a client computing system where the alerts are occurring. The support team reviews and analyzes the failure event data log files to determine the origin of the problem that resulted in collection of the failure event data log file. Frequently, the support team must locate and extract the necessary files or information from an enormous failure event data log file because they do not require all of the data contained in the file. It is a technical advantage that embodiments of the present system are able to provide a failure event data log file that contains all of the relevant log files but eliminates many of the log files that are otherwise automatically collected.

Some embodiments provide a method comprising various operations and/or a computer program product comprising a non-transitory computer readable medium and program instructions embodied therein, the program instructions being configured to be executable by a processor to cause the processor to perform various operations. The operations of the method and/or the computer program product comprise training an artificial intelligence (AI) model using a training dataset including a plurality of failure event data log files, wherein each failure event data log is labeled with an alert that caused generation of the failure event data log files and a desired collection list. The training causes the AI model to determine weights of a plurality of parameters of the AI model. The operations further comprise receiving a plurality of alerts as prompts for input to the AI model, and generating and outputting, for each of the plurality of alerts, a collection list identifying the log files and/or folders to be collected by the system management software and sent to a service support node as a failure event data log file for analyzing a cause of the alert. Still further, the operations comprise performing recursive training of the AI model, wherein the recursive training includes, for each of the plurality of alerts, calculating a loss function that identifies a difference between the collection list output by the AI model and an intended collection list for the alert, and adjusting the weights of the plurality of parameters of the AI model.

Training an AI model involves exposing the AI model to a dataset so the AI model can learn patterns and relationships within the data. This process typically begins with initializing the model's parameters, such as weights in a neural network. The model then processes the dataset, making predictions and comparing them to the actual outputs. Using an optimization algorithm like gradient descent, the model adjusts its parameters iteratively to minimize the error between its predictions and the correct answers. Over time, as the model refines these parameters, it becomes better at recognizing patterns and generalizing to new inputs. Once trained, the model can generate output in response to a given prompt by applying the learned parameters to process and interpret the input, producing responses that align with the patterns it identified during training. In the present embodiments, the AI model learns to output a collection list in response to a prompt containing an alert, wherein the alert identifies the alert type and the internal hardware device that was the source of the alert.

In some embodiments, the AI model is trained using a plurality of past failure event data log files, wherein each of the past failure event data log files is labeled to identify both the alert that caused collection of the past failure event data log file and a list of files and/or folder that were found to be important for determining the cause of the alert. The identification of the alert may include both the alert type and the identity of the hardware device that caused the generation of the alert.

In some embodiments, the method may further comprise searching, using one or more search criteria, through a database of previously generated failure event data log files to identify those failure event data log files that include content matching particular search criteria. For example, the search criteria may include an alert identifier, alert type, device serial number, exception, severity level, CPU throttling level, and/or memory usage level. The identified failure event data log files may be included in the training dataset. In one example, the search may return log files identifying a current firmware version, events history, alerts history, and/or firmware update history for the device identified in the alert.

In some embodiments, the recursive training of the AI model may continue until the loss function achieves a predetermined benchmark for the accuracy of the collection list. For example, the method may include determining whether the collection list output by the AI model matches the intended collection list identified in the training data. If it is determined that the collection list output by the AI model does not match the intended collection list, then reinforcement training may be performed on the AI model using the failure event data log file labeled with the intended collection list as training data, the weights may be adjusted by the AI model with additional filtering, and the prompt (i.e., alert as associated device and type) may be fed again to the AI model to form a new collection list. These operations may be repeated as desired, such as until the loss function achieves the predetermined benchmark.

In some embodiments, the method may further comprise performing additional filtering based on a set of weightings, wherein the weightings include a separate weighting for information logs, event logs, server logs and error logs. Alternatively, the method may further comprise performing additional filtering based of a specific time that the alert occurred and/or specific database logs.

The term “failure analysis data capture”, such as “first failure data capture” (FFDC), refers to the capability of collecting relevant operating data in response to an alert. A “failure analysis data collector” (or simply “collector”), such as an “FFDC collector”, is software used to collect the individual log files and form the failure event data log file, such as an FFDC file. In one option, the failure event data log file may be a “tape archive” file type (i.e., *.tar) that bundles multiple files and directories together into a single container. For example, the failure event data log file may contain nested zip files based on the source of the data, such as the endpoints and/or software modules from which the individual log files are collected.

It is a technical benefit of some embodiments that the failure analysis data collector may output a small and focused list of files and/or folders to be collected and submitted to the service support. While the number of zipped files included in a single failure event data log file (*.tar) is currently about 25-30, embodiments of the present failure analysis data collector dramatically reduces the total number of zipped files included in the failure event data log file. Reducing the number of files included in the failure event data log file may reduce the size of the failure event data log file to just a few megabytes, optimizing storage and resource usage.

It is a technical benefit of some embodiments that the reduced failure event data log file size will significantly reduce the amount of time required for both downloading logs from each software module and then uploading the logs to the service support upload facility. For example, downloading the logs may include both collecting the logs from each software module, zipping the logs in a single file, then downloading the zipped file to a local system or mountpath defined in a virtual machine running the system management software. By only collecting specific logs from each software module, some embodiments will reduce collection time, zipping time, CPU utilization, storage space required, and downloading bandwidth and time.

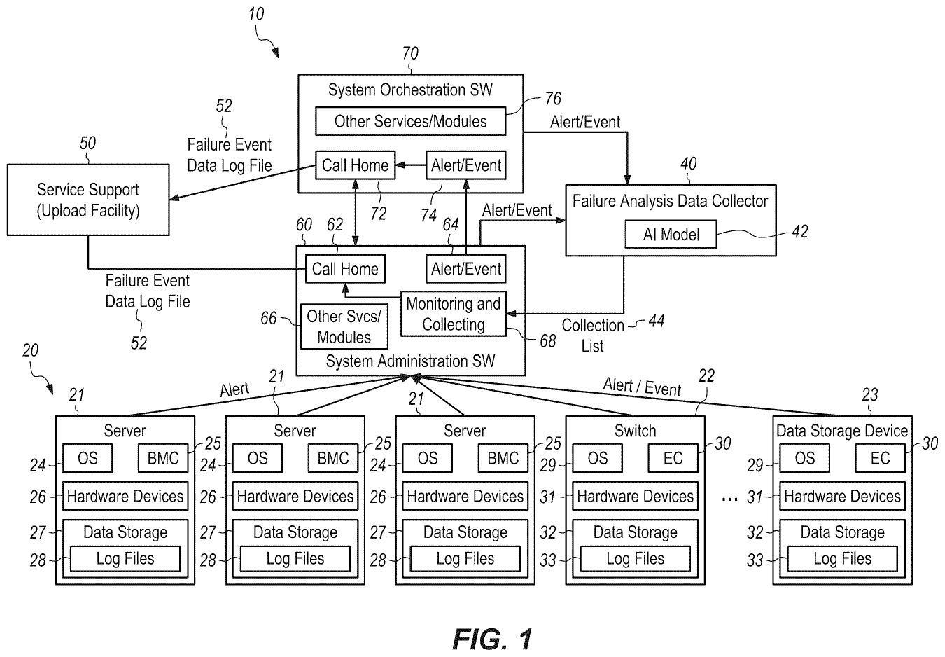

FIG. 1 is a diagram of a system 10 that forms a failure event data log file having a reduced set of files and folders selected by an AI model 42 and provided to a service support 50. A plurality of endpoint devices 20, include some number of servers 21, a switch 22 and a data storage device 23. The endpoint devices 20 are each managed by the system administration software 60 and one or more instances of the system administration software 60 are managed by the system orchestration software 70. Unless there is an alert generated among the endpoint devices 20, the failure analysis data collector 40 and the service support (upload facility) 50 are not involved. Without limitation, the system administration software 60 (such as Lenovo XClarity Administrator (LXCA)), the system orchestration software 70 (such as Lenovo XClarity Orchestrator (LXCO)), the failure analysis data collector 40 and/or the service support (upload facility) 50 may each be run on a separate hardware computing device, virtual machines operating in a cloud computing environment, or some combination thereof. Furthermore, embodiments may run the failure analysis data collector 40 on the same computing device or node as either the system administration software 60 or the system orchestration software 70.

Each of the endpoint devices 20 includes an operating system, a management controller, hardware devices, and data storage, which may vary from device to device. For example, each server 21 is shown having an operating system 24, a baseboard management controller (such as a Lenovo XClarity Controller) 25, various internal hardware devices 26, data storage 27, and log files 28 stored on the data storage 27. Similarly, the switch 22 and data storage device 23 are each shown having an operating system 29, an embedded controller 30, various internal hardware devices 31, data storage 32, and log files 33 stored on the data storage 32.

During operation of the endpoint devices 20, a plurality of log files 28, 33 may collect and store data on at least one local data storage device 27, 32 that is a component of the endpoint device (host node) 21, 22, 23. Typically, the log files 28, 33 are continuously or periodically updated with operational data or event records in the normal course of operation as the endpoint device (host node) 21, 22, 23 performs various workloads and tasks. The local data storage device 27, 32 that stores a log file will preferably include a non-volatile data storage medium, such as a magnetic disk drive or solid state drive. The plurality of log files on any of the endpoint devices 21, 22, 23 may each be stored on the same (single) local data storage device or on separate local data storage devices. Optionally, log files for a hardware device 26, 31 or a set of hardware devices may be stored in a given predetermined directory or folder, such as a/log folder. Furthermore, a log file may be provided for a single hardware device 26, 31 or process, or for a set of hardware devices (components) or processes (firmware or software), and may have a predetermined filename, perhaps with a . log file extension. While the endpoint devices (host nodes) 20 may store a plurality of log files 28, 33 on a local data storage device 27, 32 during normal operation, the system management software 60, 70 may obtain some or all of the log files 28, 33 after a hardware device (component) 26, 31, such as an expansion card, or process (firmware or software), such as the operating system 24, 29, on the endpoint device 21, 22, 23 has experienced an alert, such as a system failure.

The operating conditions of a server 21 are monitored by the local management controller, such as a baseboard management controller 25 or XClarity controller (XCC). Based upon the operating conditions of the server 21, the baseboard management controller 25 may generate an alert and send the alert to a configurable “Call Home” destination of the system management software, such as either the call home destination 62 on the system administration software (LXCA) 60 or the call home destination 72 on the system orchestration software (LXCO) 70. A “call home alert” may be output from a notification system where a device, such as a local management controller on a network server, automatically sends an alert message to a designated contact when an event or issue causes an alert to be generated. The call home alert also provides information about the problem so that troubleshooting can begin quickly. In one example, if Call Home 62 is enabled at the system administration software 60, then the baseboard management controller 25 will send the alert to the system administration software 60. The baseboard management controller 25 may automatically also send relevant log files to the system administration software 60 or send the relevant log files in response to a request received from the system administration software 60. Subsequently, the system administration software 60 will form the failure event data log file 52 and provide it directly to the service support destination 52. In another example, if the Call Home destination 62 is disabled at the system administration software 60 but the Call Home destination 72 is enabled at the system orchestration software 70, then the alert as well as the relevant log files will be sent from the baseboard management controller (BMC) 25 to the system administration software 60 and then forwarded to the system orchestration software 70 (from point 64 to point 74). Subsequently, the system orchestration software 70 will form the failure event data log file 52 and provide it directly to the service support destination 50. Optionally, the failure event data log file 52 may be compressed before sending to the service support destination 50.

The system management software (either the system administration software (LXCA) 60 or the system orchestration software (LXCO) 70) will, in response to receiving an alert, send a prompt or request containing the alert to the failure analysis data collector 40 requesting that the failure analysis data collector 40 identify the failure event data that should be collected. The failure analysis data collector 40 may categorize each alert by device identity and alert type and then provide each alert to a trained AI model 42 that generates a collection list 44 identifying files and/or folders that should be collected by the system management software and included in the failure event data log file 52. For example, the collection list 44 may identify files and/or folders that come from one or more of the endpoints 20 and/or from one or more services or modules 66, 76 of the system administration software 60 and/or the system orchestration software 70. The failure analysis data collector 40 provides the collection list 44 to the monitoring and collecting module 68 of the system management software, wherein the monitoring and collecting module 68 may be run by the system administration software 60 (as shown in FIG. 1) or may be run by the system orchestration software 70 as described herein.

For each alert, the identified device refers to the specific device, component or process of the server 21 or other endpoint 20 that suffered the alert. For example, the device may be identified by the serial number of a network interface controller (NIC), processor, memory, storage drive, etc. Furthermore, each alert may be categorized by the type of alert, such as a serviceable alert, warning alert or critical alert. For example, if the health of a solid state drive (SSD) degrades from 100% to 75%, then a warning alert may be issued. By contrast, if the solid state drive (SSD) further degrades below a threshold limit of 5%, then a critical alert may be issued.

The failure analysis data collector 40 may be both smart and lightweight. For example, the failure analysis data collector 40 may be considered “smart” because it uses an artificial intelligence (AI) model to produce a collection list 44 that will result in a failure event data log file 52 having a reduced size while still providing precise and accurate logging details. Furthermore, the failure analysis data collector 40 may be considered “lightweight” because the failure analysis data collector 40 is a very specialized collector, such that the AI model 42 does not need as many parameters and weights as is typically required by a large language model (LLM). Furthermore, the failure analysis data collector 40 outputs a collection list 44 that identifies only those log files that are relevant to the actual problem being experienced, perhaps based on message regex (regular expression), alert types, device serial number, the time that the event occurred, or power and CPU utilization metrics for the error.

The failure analysis data collector 40 may be a modular software entity that may be an application/service running either on-premises, such as in the system management software (i.e., LXCA 60 or LXCO 70), or in a public cloud. Running the failure analysis data collector 40 on-premises may provide the benefits of transferring the collection list with reduced latency and reducing concerns over network reliability, bandwidth, and resource utilization. Running the failure analysis data collector 40 as a cloud service may provide benefits that include centralized processing, scalability, and integration with other cloud services for analytics and reporting.

It should be appreciated that the size and number of log files collected and/or included in the failure event data log file 52 has an effect on the CPU utilization, power usage and bandwidth utilization by the management controller 25, 30 of the endpoint devices 20, the system administration software 60 and/or the system orchestration software 70. It is a technical benefit of the present embodiments that a collection list is generated that will lead to a failure event data log file 52 having a reduced size yet containing all of the log files and data that is actually helpful to troubleshooting the root cause of the alert. This not only reduces CPU utilization, power usage and bandwidth utilization, but is expected to save time and effort of the team of experts at the service support 50 since there are fewer log files to review.

As shown in FIG. 1, a single instance of the system administration software (LXCA) 60 may manage multiple endpoint devices 20. However, the system orchestration software (LXCO) 70 may also manage multiple instances of the system administration software (LXCA) 60. In some embodiments, if the plurality of endpoints 20 are managed by multiple instances of system administration software 60 on multiple system management nodes, which are in turn managed by a single instance of system orchestration software 70, then the log files from the local management controllers 25, 30 on the endpoints 21, 22, 23 may be collected by the system orchestration software 70. Subsequently, only those log files on the collection list 44 obtained from the failure analysis data collector 40 will be sent from the system orchestration software 70 to the service support destination (look up facility) 50. It should be recognized that if the system orchestration software 70 is collecting the log files and forming the failure event data log file 52, then that functionality is provided to the system orchestration software 70 and the collection list 44 is sent to the system orchestration software 70.

In some embodiments, if the endpoints are not managed by system management software, then the management controllers 25, 30 on each endpoint 21, 22, 23 may send its log files 28, 33 directly to the service support destination (upload facility) 50. The failure analysis data collector 40 may then be provided with the alert input (device identity and alert type) and output a collection list 44 directly to the service support destination 50. Although the service support destination 50 may already have all of the log files from the affected endpoint, the collection list 44 may still be used to automatically eliminate log files that are not on the collection list 44 from being included in the failure event data log file 52 and to request only the software module log files that are on the collection list. Accordingly, the personnel on the service support team will review the failure event data log file 52 having an improved content according to the collection list 44 generated by the failure analysis data collector 40.

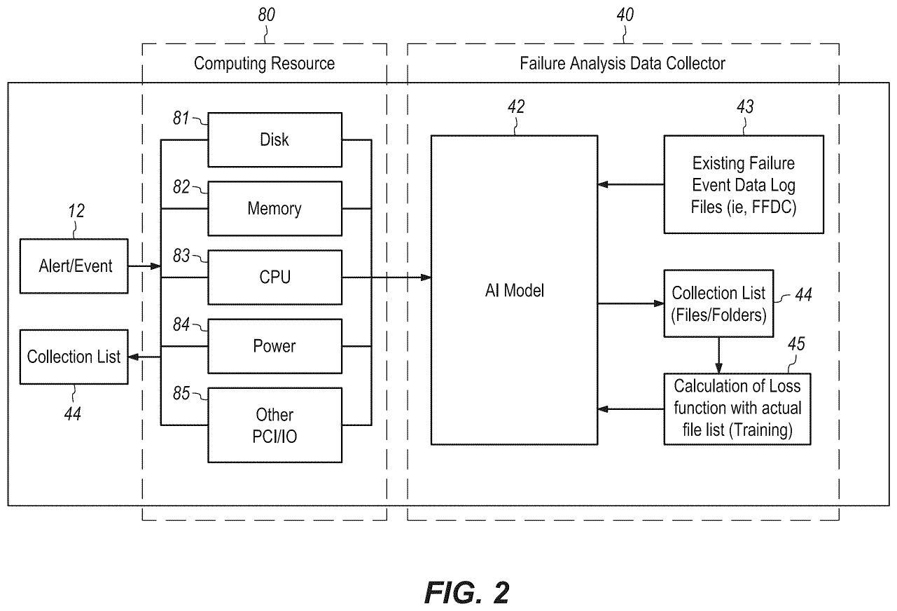

FIG. 2 is a diagram of a computing resource 80 that runs the failure analysis data collector 40. The computing resource 80 may be an individual computer or server, or may be a cloud computing environment. However, the computing resource 80 includes data storage (disk) 81, memory 82, a central processor unit (CPU) 83, a power supply 84 and other resources, such as a Peripheral Component Interconnect (PCI) components and input/output components 85. The failure analysis data collector 40 includes the AI model 42 shown in FIG. 1. Furthermore, the AI model 42 is shown receiving existing failure event data log files (i.e., FFDC) 43 as training datasets to support initial training. During the initial training and during any fine-tuning or recursive training, the AI model generates a collection list 44 identifying log files and/or folders that should be collected. Then, a loss function is calculated (at point 45) comparing the generated collection list 44 with an actual collection list (file list), such as a file list included in data accompanying or labeling the existing failure event data log files (i.e., FFDC) 43. The AI model 42 may adjust its weights and parameters in response to the loss function. Subsequent to the initial training of the AI model 42, the failure analysis data collector 40 may receive an alert or event 12, cause the AI model 42 to perform inference on the alert or event 12, then output a collection list 44 to the monitoring and collecting module 68 of the system management software. Still further, the AI model 42 may be involved in recursive training using the collection list that is output to the system management software.

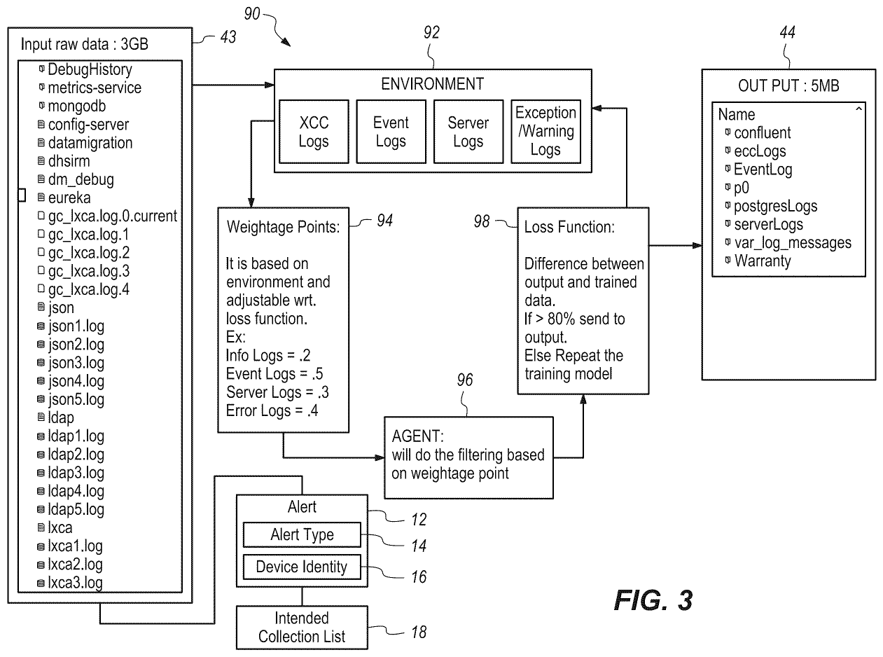

FIG. 3 is a diagram of an artificial intelligence (AI) reinforcement learning algorithm 90 for training an AI model to generate a collection list 44 that identifies select files and/or folders for inclusion in the failure event data log file 52 (see FIG. 1) that are relevant to the troubleshooting of the cause of an alert or event. An existing failure event data log file (FFDC file) 43 includes numerous log files, such as zip files, received from various software modules and hardware devices and thus has a large size of several gigabytes. The existing failure event data log file 43 is input to the AI model (see also FIG. 2) as part of a training dataset. The AI model includes an environment module, a weightage points module, an agent module and a loss function module. The AI model outputs a collection list 44 identifying a smaller number of files that are relevant to the particular alert 12 that initially caused the collection of the failure event data log file 43. The failure event data log file 43 is labeled with the alert 12, including the alert type 14 and the device identity 16 of the device or module that causes the alert, as well as an intended collection list 18.

The AI model may be trained using labeled data, such as the existing failure event data log files 43 that were previously sent to the support team or a subset of data based on the existing failure event data log files 43. Each failure event data log file 43 is labeled with the details of the alert 12 that caused collection of the FFDC files, including the identity of the device 16 that caused the alert, the type of the alert 14, and an intended collection list 18 identifying files and/or folders that were found to be important for determining the root cause of the alert. The AI model will be trained by providing large training datasets to increase accuracy and reduce the loss function. Optionally, the AI model may be trained with additional sources or types of labeled data.

The environment module uses the historical failure event log files 43 collected from the service support team and divides the data into certain frequently occurring categories for problem identification. In other words, the environment module forms categorical data from the overall failure event data log file (FFDC) collection. The illustrated categories in this non-limiting example include XCC logs, event logs, server logs and exception/warning logs, but embodiments may include additional or other categories such as DataBase and/or rabbitmq based on cloud and non-cloud platforms. The environment module also interacts with the agent module to provide the agent module with current state information for the agent to observe, then provides feedback to the agent indicating whether a current action has increased the accuracy of the output.

During the initial training phase of the AI model, the loss function 98 will be calculated iteratively to adjust the weights (numerical values that determine the strength of connections between neurons within a neural network) and ensure the model learns the basic patterns and relationships in the data. After initial training, the AI model may be fine-tuned for continuous improvement. Specifically, the AI model may be fine-tuned by calculating the loss function and making weight adjustments during normal, ongoing operation of the AI model until the loss function achieves a selected benchmark.

The AI model may determine the accuracy of the collection list (the file list that is output) 44 based on the loss function 98. For example, if the collection list 44 that is output by the AI model does not match the intended collection list 18 (i.e., one of the labels accompanying the failure event data log file 43), then the failure event data log file 43 labeled with the alert 12 and the intended collection list 18 will be provided to the AI model for reinforcement learning or training. The weights used by the AI model will be adjusted with additional filtering and then the prompt (i.e., alert and the associated device and type) is fed again to the AI model to form another collection list (output). The output collection list will be matched against the training data for accuracy again. This logic will be iterative and based on the reinforcement algorithm used.

In one option, the environment module 92 observes the current pattern, gets the current state of the environment, and the weightage points module 94 changes the category weightage points so that only one category of the data is given high priority (i.e., a higher weightage point value) and the other categories are given low priority (i.e., a lower weightage point value). With the change in category weightages, the filtering changes to ignore some of the logs from other low priority categories. In this option, the model will identify the collection list 44 (for troubleshooting the cause of the alert) using only the log files within the high priority category but might overlook other secondary or contributory problems that are only identifiable within the low priority categories of log files. In another option, the weightage points module 94 may adjust the weightage points in response to the value of the loss function determined by the loss function module 98. In this latter option, the initial weightage points may be more balanced and the agent 96 may be allowed to set the filtering criteria, but this option takes more training iterations to learn and generate output (collection list 44) that matches the desired output (the intended collection list 18).

In one example, an agent 96 may perform the additional filtering based on a set of weightings, such as the following weightings: Info Logs=0.2; Event Logs=0.5; Server Logs=0.3; Error Logs=0.4. In other options, the additional filtering may be performed on the basis of a specific time of the alert's occurrence or the specific database logs. The category weightage points are values belonging to certain categorical filtering criteria. The weightage points indicate how different state or categorical data are prioritized (“weighted”) when training an agent. If the weightage points of the logs are modified from 2 to 4, then new attributes such as username, time stamp before an operation and after an operation, and/or execution duration may be added to the filtering attributes so that more accurate information logs may be fetched. During the iterative process, the weightage points assigned to each category are adjusted to improve the accuracy of the output (collection list) based on the loss function percentage (i.e., percent difference between output and trained data).

During a training phase, the failure analysis data collector may use filtering logic 96 to search through a previously collected failure event data log file 43, perhaps stored in a history folder or database, to identify those log files that include content matching a search criteria, such as an event identifier, event type, device serial number, exception, warning level, CPU throttling level, or memory usage level. Those log files that the filtering logic 96 identifies as containing a match of the search criteria are selected from the list of all log files for use in training. For example, if a particular failure event data log file 43 is associated with an alert for a disk RAID (Redundant Array of Independent Disks) controller issue, then the algorithm used to train the AI model may search the log files to identify those files containing inventory information about the disk RAID controller including firmware details, all previous history of events, alerts and audits of the disk RAID controller, and firmware update history of the disk RAID controller.

However, after the AI model 42 (see FIGS. 1-2) has been fully trained and deployed, then the AI model no longer needs access to the failure event data log files 43. Rather, after receiving a new alert, the system management software will receive the current log files from a local management controller, local operating system, and/or various system management software modules (LXCA modules and LXCO modules). When the system management software receives the collection list 44 from the failure analysis data collector 40 that includes the AI model 42 (see FIGS. 1-2), the system management software 60, 70 (see FIG. 1) will form a new failure event data log file 52 (see FIG. 1) including only those log files that are identified in the collection list 44.

The environment module 92 serves as the dynamic state provider for the agent module 96 The environment module and the agent module have responsibilities during various steps. For example, the environment module provides the agent module with real-time event logs and historical failure data. The agent module observes the current state by analyzing input log data. The agent module applies filtering rules based on dynamically adjustable weightage points, such that logs with higher weightage points (e.g., error logs) are prioritized over less critical logs. The algorithm uses learning to correct itself based on a loss function (accuracy). The loss function evaluates the difference between the agent's output and the training data (log files 43). For example, if the accuracy of the filtered output is above a predetermined amount, such as greater than an 80% accuracy, then the data (collection list) generated by the agent module 96 is sent to the output module (see output collection list 44). If accuracy falls below the threshold, the agent receives a penalty (negative reward) and refines its filtering strategy through repeated training iterations. The AI model continuously updates its policy to improve filtering accuracy. Through multiple iterations, the agent module learns the optimal strategy for categorizing and selecting log data. This agent module interacts with the environment module and takes filtering actions based on weightage points assigned to different log types.

The current pattern observed by the environment module 92 refers to the recurring trends in the incoming failure event data logs. These patterns are detected by analyzing log frequency, error severity, and event correlations. The system identifies log frequency trends, error severity trends, correlation between logs, and noise versus signal identification. Log Frequency Trends identify when certain logs appear more frequently, indicating common system events. Error Severity Trends identify Logs containing critical errors, warnings, or failure events. Correlation Between Logs identifies patterns where a specific server log often precedes a failure event in XCC logs. Noise vs. Signal Identification involves differentiating useful logs from redundant data to optimize filtering. For example, if server logs frequently contain the same warning messages, the system may learn to reduce their weightage unless they correlate with a critical failure. If an exception log precedes a system crash, the model learns to prioritize such logs for retention.

The current state refers to the logs that the system is processing real-time. The system may observe or identify various patterns, such as (1) a pattern in which exception logs frequently correlate with system crashes, (2) a pattern in which BMC/XCC logs contain repeated warnings that do not lead to failures, and/or (3) a pattern in which event logs show increased frequency, but most are informational (low severity). The environment may identify a current state, such as (1) 3GB of raw data received, primarily from event and server logs, (2) weightage points adjusted such that exception logs are prioritized (Weight=5) and event logs are deprioritized (Weight=2), (3) loss function shows previous filtering had an accuracy level (below a predetermined accuracy threshold; 75%<80% threshold), such that the system needs retraining to improve selection, and/or (4) system alerts detected, where higher server log failures indicate a potential anomaly.

The agent module may response to the current state by (1) adjusts weightage points dynamically, (2) reprioritizes log selection based on new error trends, (3) if necessary, triggers retraining to improve filtering accuracy, and/or (4) sends the most relevant logs (e.g., server failure indicators) to the output for further analysis. By continuously learning and observing the patterns and the current state of the environment, the AI model optimizes its log filtering strategy over time, ensuring that only the most valuable information is retained while eliminating unnecessary data. Accordingly, the AI model outputs a collection list identifying the most beneficial log files.

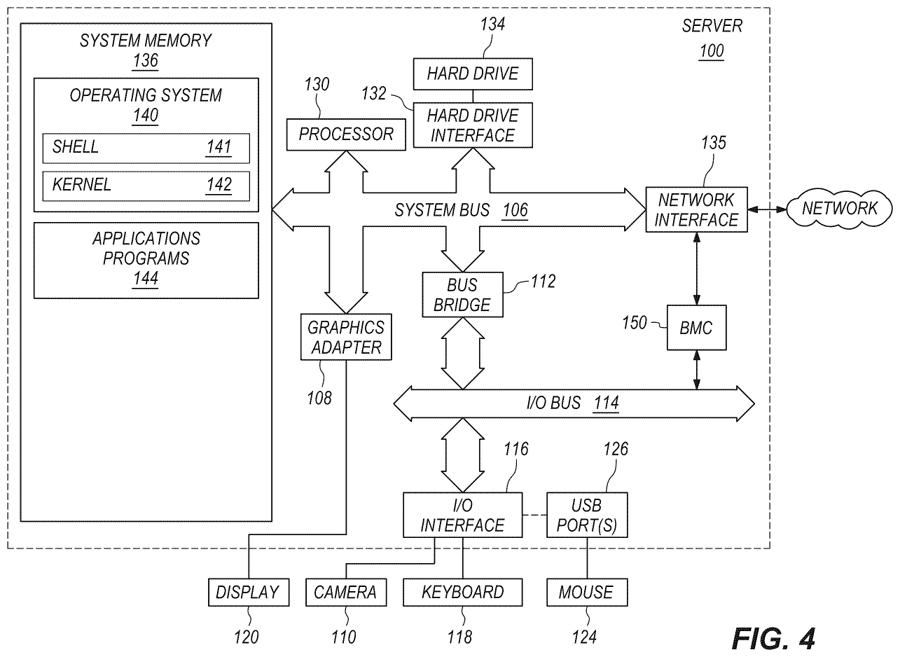

FIG. 4 is a diagram of a computer server 100 that may be representative of any of the servers 21 or a computing node hosting the system administration software 60, the system orchestration software 70, the failure analysis data collector 40 and/or the service support 50 as shown in FIG. 1. The server 100 includes a processor unit 130 that is coupled to a system bus 106. The processor unit 130 may utilize one or more processors, each of which has one or more processor cores. An optional graphics adapter 108, which may drive/support an optional display 120, is also coupled to system bus 106. The graphics adapter 108 may, for example, include a graphics processing unit (GPU). The system bus 106 may be coupled via a bus bridge 112 to an input/output (I/O) bus 114. An I/O interface 116 is coupled to the I/O bus 114, where the I/O interface 116 affords a connection with various optional I/O devices, such as a camera 110, a keyboard 118 (such as a touch screen virtual keyboard), and a USB mouse 124 via USB port(s) 126 (or other type of pointing device, such as a trackpad). As depicted, the computer 100 is able to communicate with other network devices over a network using a network adapter or network interface controller 135.

A hard drive interface 132 is also coupled to the system bus 106. The hard drive interface 132 interfaces with a hard drive 134. In a preferred embodiment, the hard drive 134 may communicate with system memory 136, which is also coupled to the system bus 106. The system memory may be volatile or non-volatile and may include additional higher levels of volatile memory (not shown), including, but not limited to, cache memory, registers and buffers. Data that populates the system memory 136 may include the operating system (OS) 140 and application programs 144. The hardware elements depicted in the server 100 are not intended to be exhaustive but rather are representative.

The operating system 114 includes a shell 141 for providing transparent user access to resources such as application programs 144. Generally, the shell 141 is a program that provides an interpreter and an interface between the user and the operating system. More specifically, the shell 141 may execute commands that are entered into a command line user interface or from a file. Thus, the shell 141, also called a command processor, is generally the highest level of the operating system software hierarchy and serves as a command interpreter. The shell may provide a system prompt, interpret commands entered by keyboard, mouse, or other user input media, and send the interpreted command(s) to the appropriate lower levels of the operating system (e.g., a kernel 142) for processing. Note that while the shell 141 may be a text-based, line-oriented user interface, the present invention may support other user interface modes, such as graphical, voice, gestural, etc.

As depicted, the operating system 140 also includes the kernel 142, which includes lower levels of functionality for the operating system 140, including providing essential services required by other parts of the operating system 140 and application programs 144. Such essential services may include memory management, process and task management, disk management, and mouse and keyboard management. In addition, the computer server 100 may include application programs 144 stored in the system memory 136.

The server 100 may further include a baseboard management controller (BMC) 50. The BMC is considered to be an out-of-band controller and may monitor and control various components of the server 100. However, the BMC may also communicate with various devices via the network interface 135 and network(s).

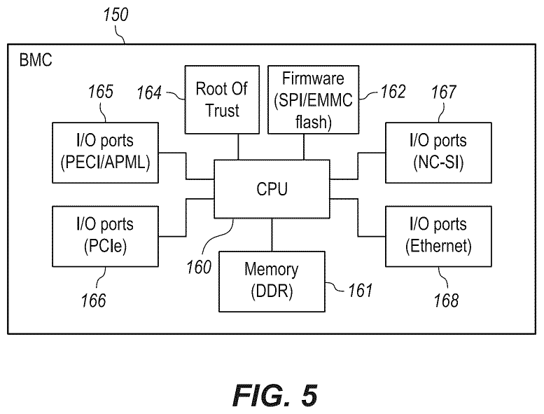

FIG. 5 is a diagram of a baseboard management controller (BMC) 150 according to some embodiments. The BMC 150 is similar to a small computer or system on a chip (SoC), including a central processing unit (CPU) 160 (which is a separate entity from the central processing units 130 in FIG. 4), memory 161 (such as random-access memory (RAM) on a double data rate (DDR) bus), firmware 162 on a flash memory (such as an embedded multi-media card (eMMC) flash memory or a serial peripheral interface (SPI) flash memory), and a root of trust (RoT) chip 164. The BMC 150 further includes a wide variety of input/output ports. For example, the input/output (I/O) ports may include I/O ports 165 to the hardware components of the server, such as a Platform Environment Control Interface (PECI) port and/or an Advanced Platform Management Link (APML) port; I/O ports 166 to the hardware components of the servers and/or a network interface controller (NIC), such as a Peripheral Component Interconnect Express (PCIe) port; I/O ports 167 to the NIC, such as a network controller sideband interface (NC-SI) port; and I/O ports 168 to a network that accessible to an external user, such as an Ethernet port. The BMC 150 may use any one or more of these I/O ports to interact with hardware devices installed on the server for purposes of monitoring and control.

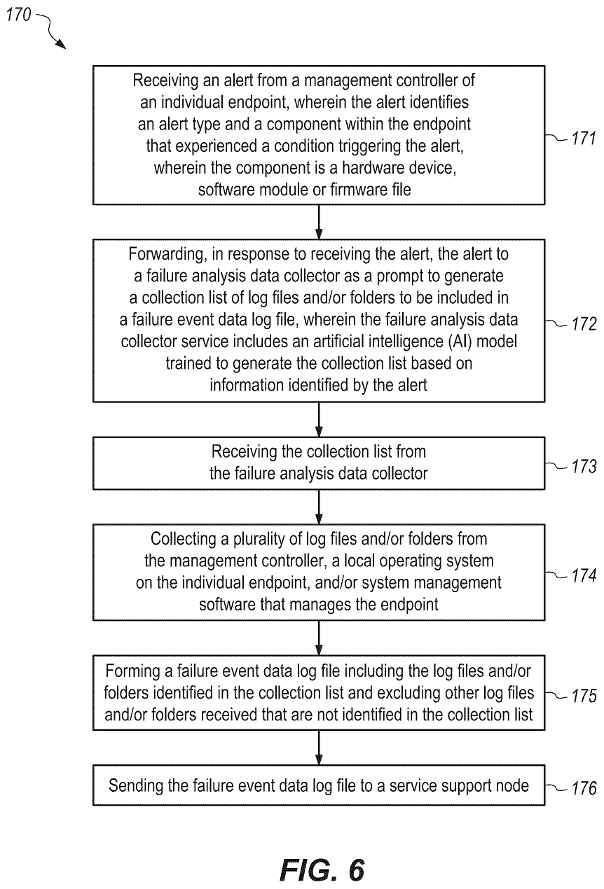

FIG. 6 is a flowchart of operations 170 that may be performed by a processor of a computing node that hosts an instance of the system management software, such as the system administration software or the system orchestration software. Operation 171 includes receiving an alert from a management controller of an individual endpoint, wherein the alert identifies an alert type and a device within the endpoint that experienced a condition triggering the alert. Operation 172 includes forwarding, in response to receiving the alert, the alert to a failure analysis data collector as a prompt to generate a collection list of log files and/or folders to be included in a failure event data log file, wherein the failure analysis data collector service includes an artificial intelligence (AI) model trained to generate the collection list based on information identified by the alert. Operation 173 includes receiving the collection list from the failure analysis data collector. Operation 174 includes collecting a plurality of log files and/or folders from the management controller, a local operating system on the individual endpoint, and/or system management software that manages the endpoint. Operation 175 includes forming a failure event data log file including the log files and/or folders identified in the collection list and excluding other log files and/or folders received that are not identified in the collection list. Operation 176 includes sending the failure event data log file to a service support node.

As will be appreciated by one skilled in the art, embodiments may take the form of a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device. Furthermore, any program instruction or code that is embodied on such computer readable storage media (including forms referred to as volatile memory) that is not a transitory signal are, for the avoidance of doubt, considered “non-transitory”.

Program code embodied on a computer readable storage medium may be transmitted using any appropriate medium, including but not limited to wireless, wireline, optical fiber cable, RF, etc., or any suitable combination of the foregoing. Computer program code for carrying out various operations may be written in any combination of one or more programming languages, including an object oriented programming language such as Java, Smalltalk, C++or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments may be described with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored on computer readable storage media is not a transitory signal, such that the program instructions can direct a computer, other programmable data processing apparatus, or other devices to function in a particular manner, and such that the program instructions stored in the computer readable storage medium produce an article of manufacture.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to limit the scope of the claims. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the embodiment.

The corresponding structures, materials, acts, and equivalents of all means or steps plus function elements in the claims below are intended to include any structure, material, or act for performing the function in combination with other claimed elements as specifically claimed. Embodiments have been presented for purposes of illustration and description, but it is not intended to be exhaustive or limited to the embodiments in the form disclosed. Many modifications and variations will be apparent to those of ordinary skill in the art after reading this disclosure. The disclosed embodiments were chosen and described as non-limiting examples to enable others of ordinary skill in the art to understand these embodiments and other embodiments involving modifications suited to a particular implementation.

What is claimed is:

1. A computer program product comprising a non-transitory computer readable medium and program instructions embodied therein, the program instructions being configured to be executable by a processor to cause the processor to perform operations comprising:
receiving an alert from a management controller of an individual endpoint, wherein the alert identifies an alert type and a component within the endpoint that experienced a condition triggering the alert, wherein the component is a hardware device, software module or firmware file;
forwarding, in response to receiving the alert, the alert to a failure analysis data collector as a prompt to generate a collection list of log files and/or folders to be included in a failure event data log file, wherein the failure analysis data collector service includes an artificial intelligence model trained to generate the collection list based on information identified by the alert;
receiving the collection list from the failure analysis data collector;
collecting a plurality of log files and/or folders from the management controller, a local operating system on the individual endpoint, and/or system management software that manages the endpoint;
forming a failure event data log file including the log files and/or folders identified in the collection list and excluding other log files and/or folders received that are not identified in the collection list; and
sending the failure event data log file to a service support node.

2. The computer program product of claim 1, the operations further comprising:
collecting an additional plurality of log files and/or folders from additional endpoints being managed by the same system management software that manages the endpoint from which the alert is received.

3. The computer program product of claim 1, wherein the system management software includes a plurality of modules, and wherein the log files and/or folders are collected from two or more of the plurality of modules.

4. The computer program product of claim 1, the operations further comprising:
managing a plurality of endpoints, wherein the endpoints include a plurality of servers, each server including a management controller.

5. The computer program product of claim 4, wherein the endpoints further include one or more switches, fans, power supplies, and/or storage devices.

6. The computer program product of claim 1, the operations further comprising:
placing the failure event data log file in a tape archive file type with multiple files and directories together into a single container.

7. The computer program product of claim 1, wherein the failure event data log file contains nested zip files based on the source of the data, such as the endpoints and/or software modules from which the individual log files are collected.

8. The computer program product of claim 1, wherein the alert is a call home alert.

9. The computer program produce of claim 1, the operations further comprising:
compressing the failure event data log file before sending the failure event data log file to the service support node.

10. The computer program product of claim 1, wherein the failure event data log file is a First Failure Data Capture file.

11. The computer program product of claim 1, wherein the system management software includes system management administrative software managing a plurality of endpoints and system orchestration software managing the system management administrative software, wherein either the system management administrative software or the system orchestration software has been designated as a Call Home destination, and wherein the failure event data log file is formed by the system management software designated as the Call Home destination.

12. The computer program product of claim 1, wherein the system management software includes a plurality of instances of system management administrative software system and system orchestration software managing the plurality of instances of the system management administrative software, wherein each instance of the system management administrative software system manages a plurality of endpoints, and wherein the failure event data log file is formed by the system orchestration software.

13. The computer program product of claim 1, wherein the artificial intelligence model has been trained using a plurality of past failure event data log files, wherein each of the past failure event data log files is labeled to identify both the alert that caused collection of the past failure event data log file and a list of files and/or folder that were found to be important for determining the cause of the alert.

14. A method, comprising:
training an artificial intelligence model using a training dataset including a plurality of failure event data log files, wherein each failure event data log is labeled with an alert that caused generation of the failure event data log files and a desired collection list, and wherein the training causes the artificial intelligence model to determine weights of a plurality of parameters of the artificial intelligence model;
receiving a plurality of alerts as prompts for input to the artificial intelligence model;
generating and outputting, for each of the plurality of alerts, a collection list identifying the log files and/or folders to be collected by the system management software and sent to a service support node as a failure event data log file for analyzing a cause of the alert; and
performing recursive training of the artificial intelligence model, wherein the recursive training includes, for each of the plurality of alerts, calculating a loss function that identifies a difference between the collection list output by the artificial intelligence model and an intended collection list for the alert, and adjusting the weights of the plurality of parameters of the artificial intelligence model.

15. The method of claim 14, further comprising:
searching, using one or more search criteria, through a database of previously generated failure event data log files to identify those failure event data log files that include content matching the search criteria, wherein the search criteria includes an alert identifier, alert type, device serial number, exception, severity level, CPU throttling level, or memory usage level; and
including the identified failure event data log files in the training dataset.

16. The method of claim 15, wherein the search returns log files identifying a current firmware version, events history, alerts history, and/or firmware update history for the device identified in the alert.

17. The method of claim 1, wherein the recursive training of the artificial intelligence model continues until the loss function achieves a predetermined benchmark.

18. The method of claim 14, further comprising:
determining whether the collection list output by the artificial intelligence model matches the intended collection list identified in the training data; and
performing, in response to determining that the collection list output by the artificial intelligence model does not match the intended collection list, reinforcement training on the artificial intelligence model using the failure event data log file labeled with the intended collection list as training data;
adjusting the weights used by the artificial intelligence model with additional filtering; and
resubmitting the alert as a prompt to the artificial intelligence model to form a new collection list.

19. The method of claim 15, further comprising:
performing the additional filtering based on a set of weightings, wherein the weightings include a separate weighting for information logs, event logs, server logs and error logs.

20. The method of claim 15, further comprising:
performing the additional filtering based on a specific time that the alert occurred and/or specific database logs.
